(19) United States
(12) Patent Application Publication
(10) Pub. No.: US 2006/0264196 A1
(43) Pub. Date: Nov. 23, 2006

(54) Super-regenerative receiver with damping resistor

(76) Inventor: Chun-Wah Fan, Hong Kong (HK)

Correspondence Address: J C PATENTS, INC., 4 VENTURE, SUITE 250, IRVINE, CA, 92618, US

(21) Appl. No.: 11/134,717

(22) Filed: May 19, 2005

(51) Int. Cl. H04B 1/16

(52) U.S. Cl. 455/336; 455/334

(57) ABSTRACT

A super-regenerative receiver with a damping resistor receives an input signal to produce an output signal. The super-regenerative receiver includes a sawtooth generator, a bias source, an oscillator circuit, and a quench control circuit. The oscillator circuit includes a resonant circuit, a damping resistor, an amplifier and a quench switch. The damping resistor damps the ringing signal when turning off the quench switch.

### BACKGROUND OF THE INVENTION

1. Field of the Invention

The present invention relates to a receiver, and more particularly to a super-regenerative receiver.

2. Description of the Related Art

A super-regenerative receiver has a simple structure, usually comprising only a few electronic devices to achieve the signal-receiving purpose for long distance communication. It also is a low-cost receiver. Super-regenerative receivers, therefore, have been widely applied to low-cost remote control toys, alarm systems, and monitors.

FIG. 1A is a schematic drawing showing a conventional super-regenerative receiver. In the conventional technology, the super-regenerative receiver serving as an on-off keying (OOK) receiver is taken as an example. Referring to FIG. 1A, the super-regenerative receiver 100 comprises the resonant circuit 105, the quench control circuit 110, the quench switch 113, the NMOS transistor 115 serving as an amplifier, the sawtooth generator 120, and the bias current source 130.

The quench control circuit 110 of the super-regenerative receiver 100 controls not only the sawtooth generator 120 to determine the current of the bias current source 130, but also the quench switch 113 to determine whether the oscillator oscillates. Wherein, the oscillator comprises the resonant circuit 105 and the NMOS amplifier 115.

FIG. 1B is a drawing showing differential signals at two terminals of a capacitor in FIG. 1A. Referring to FIGS. 1A and 1B, at the start of the time period, the quench control circuit 110 turns off the quench switch 113 (disconnected), and the sawtooth generator 120 outputs a waveform with a fixed slope so that the bias current source 130 gradually increases. Accordingly, the NMOS amplifier 115 is in a bias status. When the gain of the NMOS amplifier 115 is sufficient, noises or signals of the electronic circuits would trigger the oscillator to start oscillating exponentially until the saturation status.

When the OOK signal is in the logic 0 state, the external driving signal generated by the signal source 101 is in a static state (off). Accordingly, the triggering source of the oscillator 105 is the noises of the electronic circuit. When the OOK signal is in the logic 1 state, the signal source 101 generates signals. Accordingly, the triggering source of the oscillator 105 is the external driving signal. The larger the amplitude of the external driving signal and the closer its frequency to the resonant frequency of the oscillator, the faster the oscillator is triggered, and thus, the larger the area under the waveform. In FIG. 1B, the small waveform area of the top figure represents the signals of the logic 0 state, and the large waveform area of the bottom figure represents the signals of the logic 1 state.

After the time period, the quench control circuit 110 controls the sawtooth generator 120 to close signal output so that the bias current source 130 removes the bias corresponding to the NMOS amplifier 115. Meanwhile, the quench control circuit 110 turns on the quench switch 113. Accordingly, the oscillations of the oscillator (the combination of the resonant circuit 105 and the NMOS amplifier 115) are damped due to the turn-on of the quench switch 113. Since the quench switch 113 is turned off just before the next period, no oscillation occurs until the beginning of the next period.

In the process described above, the receiver (not shown) which receives the oscillation signal samples, integrates and averages the area of the waveform during the time period of the oscillation. The more sampling of each bit, the more the reliability of the signal.

If the receiver samples and averages the waveform to obtain a mean value smaller than a pre-set value, the receiver (not shown) takes the signal as logic 0. Contrarily, if the receiver (not shown) generates a mean value higher than a pre-set value, the receiver takes the signal as logic 1. Accordingly, the OOK control signal can be demodulated.

Following is detailed description of the effect brought by the quench switch 113. FIG. 2A is a drawing showing a simple LC oscillator with a quench switch. The simple oscillator is composed of a capacitor C, and an inductor L. The circuit is coupled to a DC current source. As shown in FIG. 2B, when the switch is turned off at t=0, ringing signals are generated in the circuit. Due to the damping in the circuit, the ringing signals are gradually damped. The ringing frequency is the resonance frequency of the capacitor and inductor of the circuit.

FIG. 3A is a drawing showing an energy-storing circuit of the oscillator with the quench switch. Referring to FIG. 3A, the signal source 201 of the circuit generates a sine-wave signal which has a different frequency from that of the oscillator 205. In this embodiment, the resonant frequency of the oscillator 205 is set as 27 MHz. The frequency of the sine-wave signal generated by the signal source 201 is 35 MHz. Under this circumstance, if the switch is turned off, the oscillation signals can be found in the circuit. Obviously, the signals comprise the 35-MHz signals and signals with other frequencies.

In order to identify the feature of the oscillation signals, an ideal buffer 270 is added in the circuit, which is coupled to a 35-MHz band-stop filter 280 to screen the 35-MHz signals for observation. After the oscillating and screening of the circuit devices described above, a weak 27-MHz ringing signal can be observed at the output terminal of the band-stop filter 280 as shown in FIG. 3B.

In other words, 35 MHz is not the receiving band of the oscillator 205, but the undesired 27-MHz signal is generated as an interference noise. Accordingly, turning off the switch would trigger a signal in the resonant frequency. That is, though the input signal has 35 MHz, the receiver is actually triggered by the signals with 35 MHz and 27 MHz. In other words, the sensitivity of the receiver with respect to the out-of-band input signal, i.e., the frequency outside of 27 MHz input signal, is increased. Thus, the frequency selectivity of the receiver relatively declines.

The LC oscillator of the conventional super-regenerative receiver has a wider receiving band. If a device with a high quality factor Q is placed, such as a surface acoustic wave (SAW) device, the frequency selectivity can be enhanced. Such expensive device, however, is not suitable for low-price electronic products.

### SUMMARY OF THE INVENTION

Accordingly, the present invention is directed to a super-regenerative receiver with a damping resistor. The damping resistor damps the ringing signals when turning off the quench switch.

The present invention provides a super-regenerative receiver for receiving an input signal to output an output signal. The super-regenerative receiver comprises a bias current source, an oscillator circuit, a damping resistor, a sawtooth generator, and a quench control circuit. The bias current source provides a bias to an amplifier. The sawtooth generator controls a bias current generated from the bias current source. The oscillator circuit is coupled to the bias current source. The oscillator circuit comprises a resonant circuit, a damping resistor, an amplifier and a quench switch. The resonant circuit comprises a LC oscillator circuit. The damping resistor is coupled to the resonant circuit, for damping the ringing signal when turning off the quench switch. The amplifier provides the gain required by the resonant circuit. The quench switch quenches the oscillation of the oscillator circuit. The quench control circuit, the quench switch of the oscillator circuit, and the sawtooth generator are coupled to each other so that the resonant circuit periodically generates the output signal.

According to the super-regenerative receiver with a damping resistor of an embodiment of the present invention, the damping resistor is a non-linear resistor.

According to the super-regenerative receiver with a damping resistor of an embodiment of the present invention, the resonant circuit is series connected with the damping resistor.

According to the super-regenerative receiver with a damping resistor of an embodiment of the present invention, the resonant circuit is parallel connected to the damping resistor.

In the present invention, due to the introduction of the damping resistor, the ringing signal resulted from switching off the quench switch while driven by out-of-band signal is substantially damped. Accordingly, the sensitivity of the out-of-band frequency is reduced, and the selectivity of frequency is thus improved.

The above and other features of the present invention will be better understood from the following detailed description of the embodiments of the invention that is provided in communication with the accompanying drawings.

### BRIEF DESCRIPTION OF THE DRAWINGS

FIG. 1A is a schematic drawing showing a conventional super-regenerative receiver.

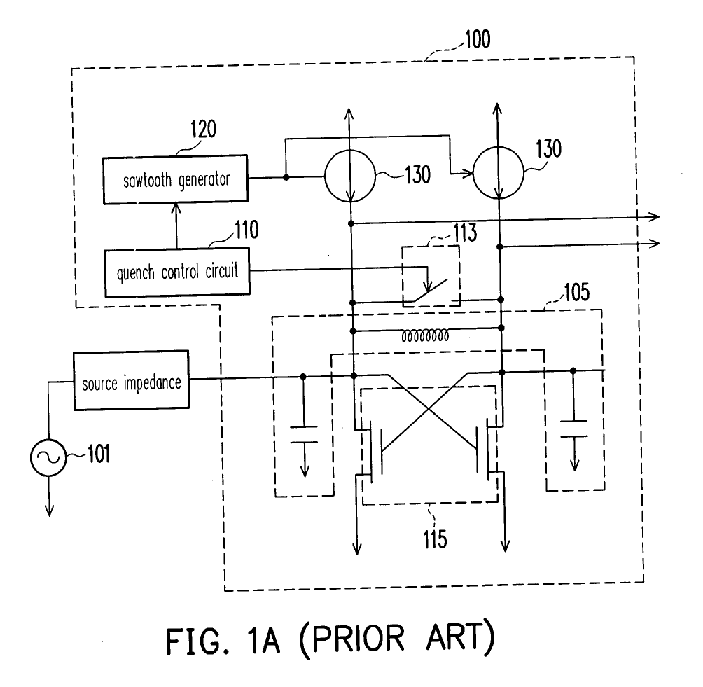

FIG. 1B is a drawing showing differential signals at two terminals of a capacitor in FIG. 1A.

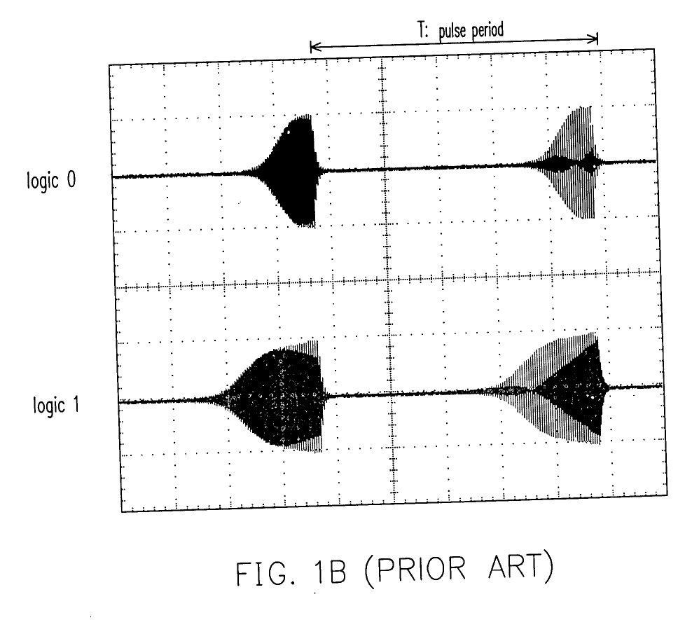

FIG. 2A is a drawing showing a simple LC oscillator with a quench switch.

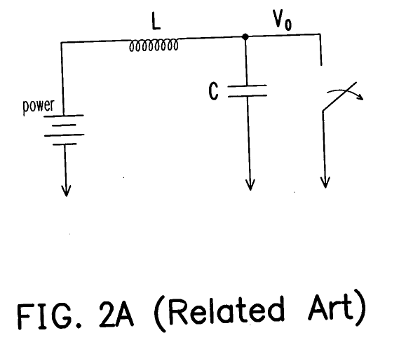

FIG. 2B is a drawing showing waveforms at a node of the capacitor in FIG. 2A.

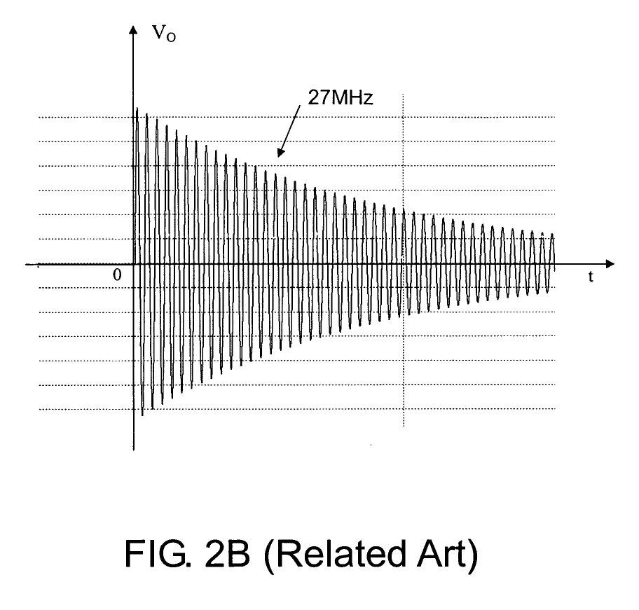

FIG. 3A is a drawing showing an energy-storing circuit of the oscillator with the quench switch.

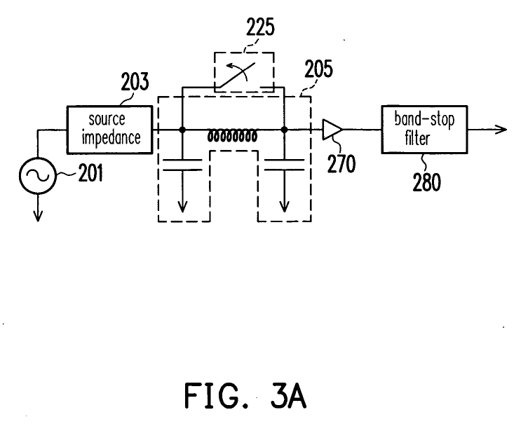

FIG. 3B is a drawing showing an output ringing waveform in FIG. 3A.

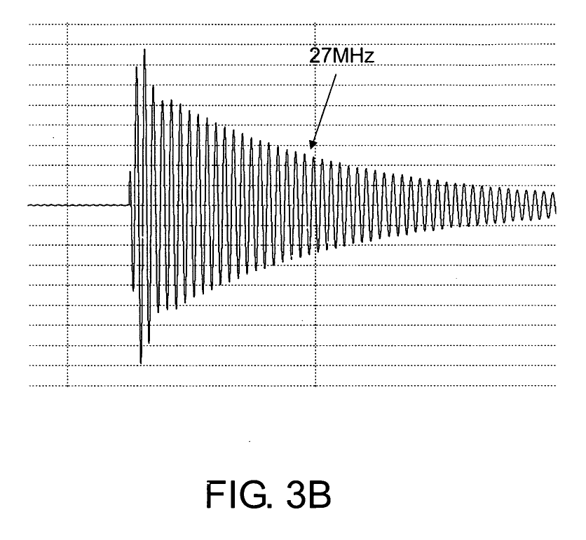

FIG. 4 is a schematic drawing showing a super-regenerative receiver according to an embodiment of the present invention.

FIG. 5 is a schematic drawing showing an output waveform envelop generated by a super-regenerative receiver with a 27-MHz frequency according to an embodiment of the present invention.

FIG. 6 is a drawing showing different frequency selectivity of a super-regenerative receiver.

FIG. 7 is a schematic drawing showing a super-regenerative receiver according to another embodiment of the present invention.

FIG. 8 is a schematic drawing showing a super-regenerative receiver according to yet another embodiment of the present invention.

### DESCRIPTION OF SOME EMBODIMENTS

In the conventional super-regenerative receiver, while the quench switch is turned off, the out-of-band input signal generates the in-band ringing signals. As a result, the sensitivity of the out-of-band signal is increased, and the frequency selectivity is down.

In the present invention, a damping resistor is added, so the in-band ringing signals can be immediately damped. As long as the in-band ringing signals can be swiftly damped, the receiver will not be triggered by the ringing signals. The sensitivity of the out-of-band signals is thus reduced, and the frequency sensitivity is improved.

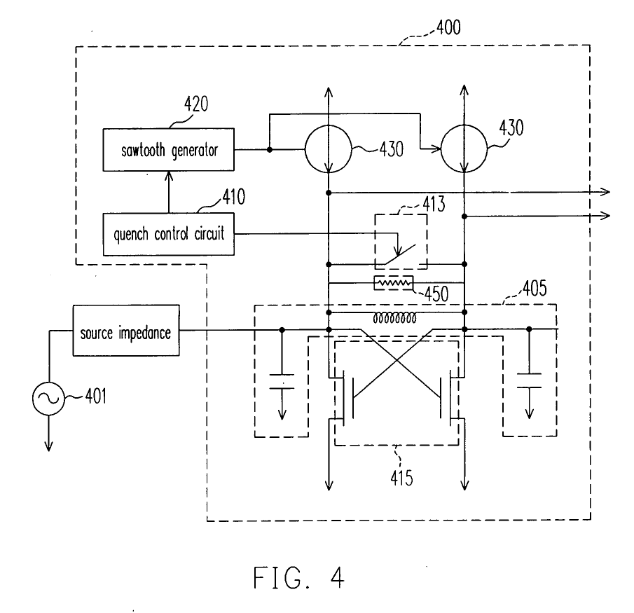

The following is the description of some embodiments of the present invention. FIG. 4 is a drawing showing a super-regenerative receiver according to an embodiment of the present invention. In this embodiment, the super-regenerative receiver serves as an OOK logic circuit, and the LC of the resonant circuit in this embodiment is designed to receive a 27-MHz frequency to generate a resonant frequency. The super-regenerative receiver 400 comprises the resonant circuit 405, the quench control circuit 410, the quench switch 413, the NMOS transistor 415 serving as an amplifier, the sawtooth generator 420, the bias current source 430, and the damping resistor 450.

The quench control circuit 410 of the super-regenerative receiver 400 controls not only the sawtooth generator 420 to determine the current generated from the bias current source 430 so as to apply a bias to the NMOS transistor 415, but the quench quench switch 413 to operate the resonant circuit 405.

At the beginning of the time period, the quench control circuit 410 not only turns off the quench switch 413, but makes the sawtooth generator 420 start outputting a waveform with a fixed slope. Thus, the bias current source 430 generates increasing bias. When the bias of the bias current source 430 reaches a standard, the oscillator, i.e. the combination of the resonant circuit 405 and the NMOS transistor 415, starts oscillating. The start time of the oscillation depends on the strength of the bias current, and the strength and frequency of the external driving signal generated by the signal source 401. If the external driving signal is an in-band signal, a small amplitude of the signal is enough to trigger the oscillation of the oscillator, i.e. the combination of the resonant circuit 405 and the NMOS transistor 415. In another aspect, if the external driving signal is an out-of-band signal, a great amplitude of the signal is required to trigger the oscillator, i.e. the combination of the resonant circuit 405 and the NMOS transistor 415.

If the signal source 401 only generates the out-of-band driving signal with a 35-MHz frequency in this embodiment, the ringing signal with a 27-MHz frequency is triggered, while the quench switch 413 is turned off. Like an external driving signal, the ringing signal with the 27-MHz frequency triggers the oscillators 405 and 415. Therefore, the amplitude of the ringing signal with the 27-MHz frequency must be immediately damped so that the oscillator, i.e. the combination of the resonant circuit 405 and the NMOS transistor 415, is triggered only by the signal with the 35-MHz frequency.

The damping resistor 450 damps out the oscillation noises to the noise level, and the oscillation signals would not affect the driving signals detected by the oscillator 405. Accordingly, the sensitivity of the out-of-band signal can be reduced, and the frequency selectivity is thus enhanced.

After a time period, the quench control circuit 410 not only makes the sawtooth generator 420 stop outputting the waveform so that the bias current source 430 does not create bias, but turns on the quench switch 413 so that two terminals of the inductor of the oscillator circuit are connected and that the oscillator, i.e. the combination of the resonant circuit 405 and the NMOS transistor 415, does not oscillate. In the process described above, the receiver (not shown) which receives the signal samples the area of the waveform during the time period of the oscillation. If the value is smaller than a pre-set value, the receiver takes the signal as logic 0. Contrarily, the receiver (not shown) which receives the signal samples the area of the waveform during the time period of the oscillation. If the value is higher than a pre-set value, the receiver takes the signal as logic 1.

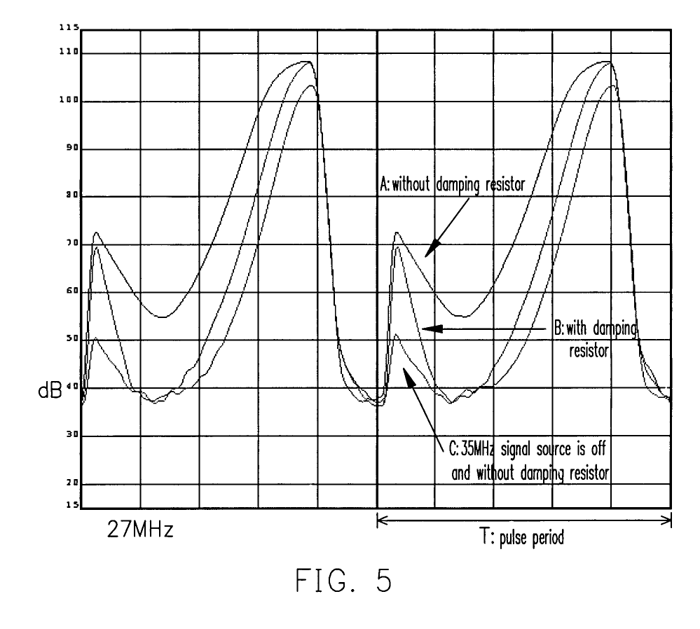

The following is the description of adding the damping resistor which damps out the ringing signals and enhances the frequency selectivity. FIG. 5 is a schematic drawing showing an output waveform envelop generated by a super-regenerative receiver with a 27-MHz frequency according to an embodiment of the present invention. Wherein, the horizontal axis represents the time period T. Since the analysis of the signals is set at 27 MHz, the waveform signal is sampled at 27 MHz. Signals with other frequencies are not shown. In this embodiment, two time periods are sampled. The unit of the vertical axis is dB, in which the damped amplitude of the interference noises by the damping resistor is shown. The waveform A is a waveform with 35-MHz frequency generated by a conventional super-regenerative receiver without a damping resistor. The waveform B is a waveform with 35-MHz frequency generated by a super-regenerative receiver with a damping resistor according to an embodiment of the present invention. The waveform C is a waveform generated by a conventional super-regenerative receiver in which the signal source is turned off.

Referring to FIGS. 4 and 5, when the quench control circuit 410 turns off the quench switch 413, lots of signals with the 27-MHz frequency are generated. If the external driving signals exist, the triggered signals are larger. If the damping resistor 450 is added, compared with the waveform A in the example without the damping resistor, in the waveform B, the ringing signals are damped more quickly. After the in-band oscillation signals are removed, the receiver is triggered only by the out-of-band signals with the 35-MHz frequency.

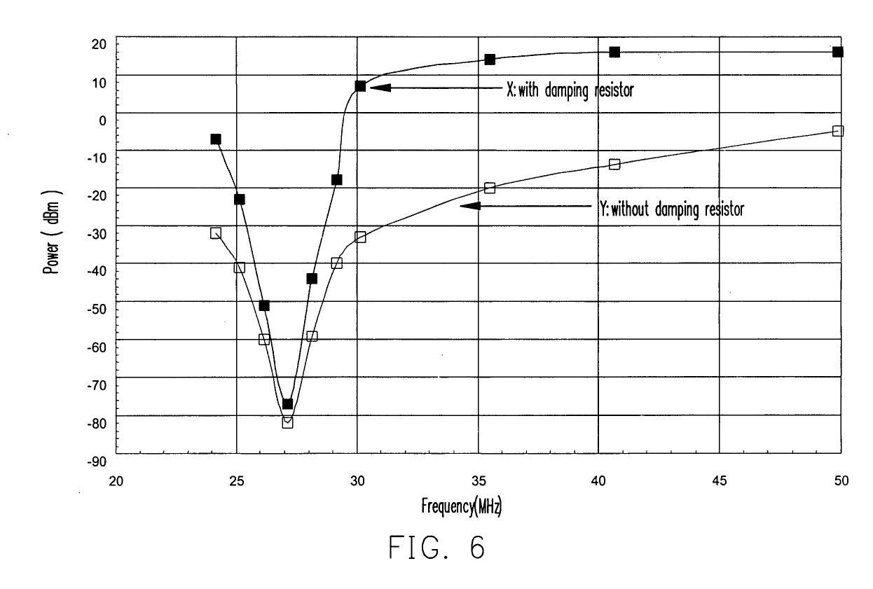

FIG. 6 is a drawing showing different frequency selectivity of a super-regenerative receiver. The thick line X represents the experimental data of the super-regenerative receiver with the damping resistor according to an embodiment of the present invention. The thin line Y represents the experimental data of the conventional super-regenerative receiver without the damping resistor. From the lines X and Y in FIG. 6, −80 dBm level is required to receive the 27-MHz signals. For receiving the 35-MHz signals, +10 dBm level is required in the line X, which is more than 30 dB compared with −20 dBm level of the line Y. Accordingly, the frequency selectivity is increased from 60 dB to 90 dB.

In the conventional technology, as long as a resistor is added in the LC oscillator, the quality factor Q becomes weak, which results in the decline of the frequency selectivity. In this embodiment of the present invention, the quality factor Q, however, is compensated by the active device NMOS transistor. At the beginning of the time period T, the bias current in the NMOS transistor is small. The quality factor Q thus is not compensated by the active device. As the bias current increases, the negative conductance generated by the NMOS transistor also rises. After the current of the bias current source rises to a level, the negative conductance generated by the NMOS transistor compensates the positive conductance of the damping resistor. Accordingly, the resistance of the damping of the resistor is offset. The quality factor Q, therefore, does not decline.

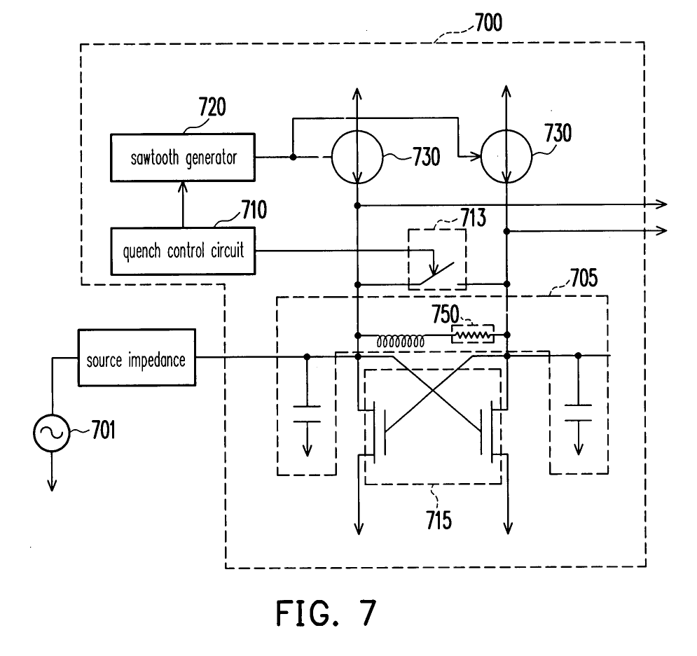

The following is another embodiment of the present invention. Not only can the damping resistor be parallel coupled to the inductor of the oscillator, but they can be coupled to the inductor in series. FIG. 7 is a schematic drawing showing a super-regenerative receiver according to another embodiment of the present invention. Referring to FIG. 7, the super-regenerative receiver 700 comprises the resonant circuit 705, the quench control circuit 710, the quench switch 713, the NMOS transistor 715 serving as an amplifier, the bias current source 730, the sawtooth generator 720, and the damping resistor 750. Wherein, the inductor L1 of the resonant circuit 705 is coupled to the damping resistor 750 in series. Other connection methods are shown in FIG. 7. Detailed descriptions are not repeated.

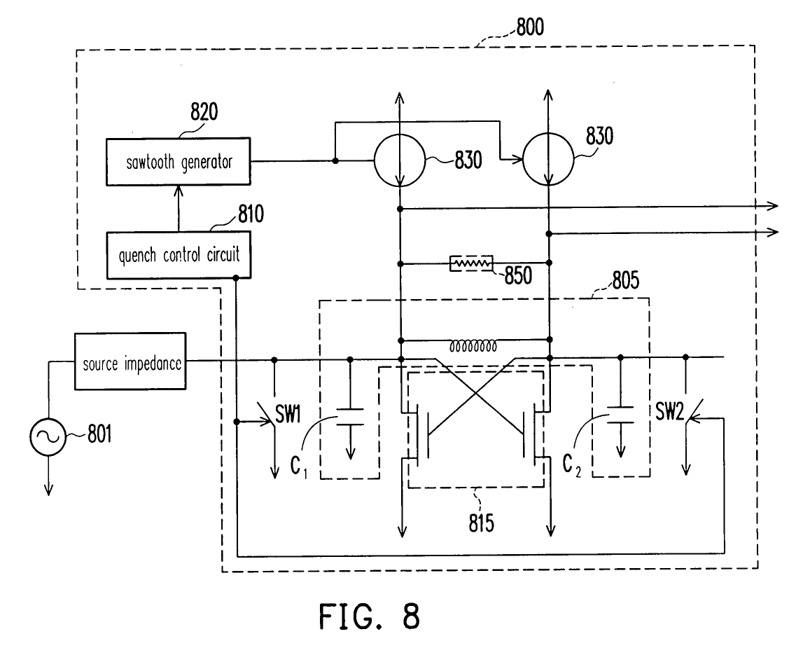

The following is yet another embodiment of the present invention. Not only can quench switch be parallel coupled to the inductor of the resonant circuit, but the quench switch can be parallel coupled between two capacitors. FIG. 8 is a schematic drawing showing a super-regenerative receiver according to yet another embodiment of the present invention. Referring to FIG. 8, the super-regenerative receiver 800 comprises the resonant circuit 805, the quench control circuit 810, the quench switches SW1 and SW2, the NMOS transistor 815 serving as an amplifier, the bias current source 830, the sawtooth generator 820, and the damping resistor 850. Wherein, the capacitor C1 of the resonant circuit 805 is parallel coupled to the quench switch SW1; the capacitor C2 is parallel coupled to the quench switch SW2, and then coupled to two terminals of the damping resistor 850. The quench control circuit 810 is coupled to the quench switches SW1 and SW2. Other connection methods are similar to those shown in FIG. 4. Detailed descriptions are not repeated.

The principle of the present invention is to damp the resonant circuit. Accordingly, the added resistor can be disposed at any place of the resonant circuit. Due to this operational principle, a terminal of the damping resistor can be coupled to the resonant circuit, and another terminal of the damping resistor can be grounded. Additionally, the damping resistor is not limited to a linear resistor. It can be a non-linear resistor.

In the embodiment of FIG. 4, if there is no quench switch 413, the quench control circuit 410 turns off the bias current source 130 through the sawtooth generator 420. The amplitudes of the oscillations of the oscillator, i.e. the combination of the resonant circuit 405 and the NMOS transistor 415, are gradually damped by the natural loss of the LC circuit. Compared with the conventional super-regenerative receiver, the oscillation signal of the invention decays faster due to the damping of the damping resistor. The residual oscillation energy thus does not affect the subsequent oscillations. That is, the hang-over effect can be avoided.

In the present invention, a damping resistor is added in the resonant circuit so that due to the introduction of the damping resistor, the ringing signal resulted from switching off the quench switch while driven by out-of-band signal is substantially damped. Accordingly, the sensitivity of the out-of-band frequency is reduced, and the selectivity of frequency is thus improved.

Although the present invention has been described in terms of exemplary embodiments, it is not limited thereto. Rather, the appended claims should be constructed broadly to include other variants and embodiments of the invention which may be made by those skilled in the field of this art without departing from the scope and range of equivalents of the invention.

What is claimed is:

1. A super-regenerative receiver for receiving an input signal to output an output signal, the super-regenerative receiver comprising:
a bias source to provide a bias; and
an oscillator circuit, coupled to the bias source, comprising:
a resonant circuit, comprising an LC oscillator circuit, the LC oscillator circuit generating the output signal with a specific frequency according to the bias and the input signal;
a damping resistor, coupled to the resonant circuit, for damping the ringing signal in the resonant circuit;
at least one amplifier, coupled to the resonant circuit, for providing a gain to the resonant circuit; and
a quench switch, coupled to the LC oscillator circuit, for controlling an output of the resonant circuit; and
a quench control circuit, coupled to the quench switch of the oscillator circuit and the bias circuit, for controlling the quench switch so that the resonant circuit periodically outputs the output signal, and determining whether the bias source should provide the bias.

2. The super-regenerative receiver of claim 1, wherein the damping resistor is a non-linear resistor.

3. The super-regenerative receiver of claim 1, wherein the resonant circuit of the oscillator circuit is parallel connected to the damping resistor of the oscillator circuit.

4. The super-regenerative receiver of claim 1, wherein the resonant circuit of the oscillator circuit is series connected with the damping resistor of the oscillator circuit.

5. The super-regenerative receiver of claim 1, wherein the oscillator circuit comprises a first capacitor, a second capacitor, an inductor, a first NMOS transistor, a second NMOS transistor, the damping resistor, and the quench switch; a terminal of the first capacitor, a terminal of the inductor, a terminal of the damping resistor, a terminal of the quench switch, a gate of the second NMOS transistor, and a drain of the first NMOS transistor are coupled to a first node; a terminal of the second capacitor, another terminal of the inductor, another terminal of the damping resistor, another terminal of the quench switch, a gate of the first NMOS, and a drain of the second NMOS transistor are coupled to a second node; and another terminal of the first capacitor, another terminal of the second capacitor, a source of the first NMOS transistor, and a source of the second NMOS transistor are grounded.

6. The super-regenerative receiver of claim 1, wherein the oscillator circuit comprises a first capacitor, a second capacitor, an inductor, a first NMOS transistor, a second NMOS transistor, the damping resistor, and the quench switch; a terminal of the inductor is coupled to a terminal of the damping resistor; a terminal of the first capacitor, another terminal of the inductor, a terminal of the quench switch, a gate of the second NMOS transistor, and a drain of the first NMOS transistor are coupled to a first node; a terminal of the second capacitor, another terminal of the damping resistor, another terminal of the quench switch, a gate of the first NMOS, and a drain of the second NMOS transistor are coupled to a second node; and another terminal of the first capacitor, another terminal of the second capacitor, a source of the first NMOS transistor, and a source of the second NMOS transistor are grounded.

7. The super-regenerative receiver of claim 1, wherein the oscillator circuit comprises a first capacitor, a second capacitor, an inductor, a first NMOS transistor, a second NMOS transistor, the damping resistor, a first quench switch and a second quench switch; a terminal of the first capacitor, a terminal of the inductor, a terminal of the damping resistor, a terminal of the first quench switch, a gate of the second NMOS transistor, and a drain of the first NMOS transistor are coupled to a first node; a terminal of the second capacitor, another terminal of the inductor, another terminal of the damping resistor, a terminal of the second quench switch, a gate of the first NMOS, and a drain of the second NMOS transistor are coupled to a second node; and another terminal of the first capacitor, another terminal of the second capacitor, a source of the first NMOS transistor, a source of the second NMOS transistor, another terminal of the first quench switch, and another terminal of the second quench switch are grounded.

8. The super-regenerative receiver of claim 1, wherein the oscillator circuit further comprises a sawtooth generator.
